(19) United States
(12) Patent Application Publication
(10) Pub. No.: US 2009/0232726 A1
(43) Pub. Date: Sep. 17, 2009

(54) Method for manufacturing alumina particles

(75) Inventors: Hiroaki Yotou, Kariya-shi (JP); Miho Itoh, Aichi-ken (JP); Tomoya Itakura, Aichi-ken (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/381,429

(22) Filed: Mar. 12, 2009

(30) Foreign Application Priority Data
Mar. 13, 2008 (JP) 2008-063912
Jan. 20, 2009 (JP) 2009-009881

(51) Int. Cl. C01F 7/02

(52) U.S. Cl. 423/625

(57) ABSTRACT

A method for manufacturing alumina particles having a size on the order of nanometers and an excellent heat resistance at about 1000° C. comprises providing a liquid medium containing particles made of γ-alumina or boehmite alumina hydrate and a metal component such as La, Ba, Mg or the like, and thermally treated the alumina and the metal component in the liquid medium in a pressurized condition. The thermally treated particles are dried and sintered at a temperature of from 900° C. to lower than 1200° C. to provide alumina particles which has a metal aluminate crystal phase thereon. The metal component is formed as a solid solution as a surface layer of individual alumina particles by subjecting the alumina particles and the metal component to the thermal treatment prior to sintering, so that the metal aluminate crystal phase can be formed by sintering at temperatures lower than ordinary sintering temperatures.

### CROSS-REFERENCE TO RELATED APPLICATIONS

This application is related to Japanese Patent Application Nos. 2008-063912 and 2009-009881, filed on Mar. 13, 2008 and Jan. 20, 2009, the contents of which are hereby incorporated by reference.

### BACKGROUND OF THE INVENTION

1. Field of the Invention

This invention relates to a method for manufacturing alumina particles used as a catalyst carrier.

2. Technical Background

As is known in the art, catalyst bodies have been in use in the automotive field for the purpose of cleaning harmful components, such as HC, CO, NOx and the like, contained in exhaust gases. Such a catalyst body is one wherein noble metal particles and promoter particles are provided as catalyst components and are supported on a porous inorganic substrate, typical of which is cordierite, through metal oxide particles serving as a catalyst carrier. This type of catalyst body is described, for example, in Japanese Laid-open Patent Application No. 2003-80077.

In this type of catalyst body, since the catalyst components are supported on metal oxide particles whose specific surface area is larger than that of the porous inorganic substrate, the catalyst components can be supported on the porous inorganic substrate in higher dispersion, thus being advantageous in that the requirement of the catalyst component can be supported.

Such metal oxide particles include, for example, alumina particles whose crystal phase is a γ phase as is particularly described in Japanese Laid-open Patent Application No. 2002-316049 and particles of a metal aluminate that is a composite oxide of Al and a metal other than Al as described in Japanese Laid-open Patent Application No. 2003-335517. The metal aluminate has the same meaning as aluminate compound and the metal aluminate particles can be obtained by subjecting boehmite alumina hydrate to normal pressure sintering in a gas phase at 1200° C. or over. It will be noted that alumina of a γ phase is hereinafter called γ-alumina.

In Japanese Laid-open Patent Application No. 2008-12527, metal oxide particles used are alumina particles obtained by subjecting γ-alumina particles alone to thermal treatment in water under pressure.

In such catalyst bodies as set out above, when a catalyst component has a small size on the order of nanometers, especially, ranging from 1 nm to 100 nm, it is desirable that the metal oxide particles be small in order to ensure higher dispersion of the catalyst component.

Because of the ease in obtaining particles of a fine size, it is preferred to use γ-alumina particles as metal oxide particles, but with a problem in that they are not resistant to heat. More particularly, γ-alumina undergoes phase transition into α-alumina when the temperature is raised to about 1000° C. and this change in the crystal phase results in particle growth. Therefore, the specific surface area significantly decreases. Where a catalyst body using such alumina particles is employed in a high temperature range in the vicinity of 1000° C., a catalyst component is buried in the alumina. As a result, gas diffusion is impeded and the catalyst component is deactivated or sintered, thereby lowering the surface area of the catalyst and the catalytic activity.

On the other hand, metal aluminate particles have a good heat resistance at high temperatures in the vicinity of 1000° C. From the standpoint of the heat resistance, it is preferred to use metal aluminate particles as metal oxide particles. However, a problem is involved in that it is difficult to obtain metal aluminate particles whose size ranges 1 nm to 1000 nm. More particularly, where particles made of boehmite alumina hydrate are merely sintered, the particle size becomes larger owing to the mutual aggregation or sintering of the particles. This results in the formation of secondary particles having, for example, a micron order, not monodispersed primary particles.

It should be noted that the afore-mentioned Japanese Laid-open Patent Application No. 2008-12527 deals with thermal treatment of γ-alumina particles alone wherein while suppressing the particle size of alumina particles from increasing, it is intended to improve the heat resistance of the alumina particles. This thermal treatment is carried out so as to lower a temperature of phase transition of γ-alumina into θ-alumina having a better heat resistance to 1000° or below. The alumina particles, subjected to this thermal treatment, is converted to θ-alumina after heating, for example, at 800° C., and no phase transition occurs if the temperature is increased to 1000° C. This enables a change in specific surface area to become small when the temperature is raised from 800° C. to 1000° C., thereby improving the heat resistance of the alumina particles. In the technique of this patent application, attention is drawn to the excellence of θ-alumina with respect to the heat resistance in the vicinity of 1000° C., but not drawn to the excellence in heat resistance of a metal aluminate in the vicinity of 1000° C.

### SUMMARY OF THE INVENTION

It is accordingly an object of the invention to provide the manufacture, in a manner different from the manufacturing method set out in the above Laid-open Patent Application No. 2008-12527, of alumina particles that have a size on the order of nanometers, especially from 1 nm to 100 nm and are good at heat resistance in the vicinity of 1000° C.

According to the invention, there is provided a method for manufacturing alumina particles, the method comprising providing particles made of γ-alumina or boehmite alumina hydrate and a metal component selected from at least one of La, Ba, Mg, Ce, Na, K, Sr and Ca, both contained in a liquid medium, and subjecting the particles dispersed in the liquid medium and the metal component to thermal treatment in the liquid medium under pressurized conditions, i.e. hydrothermal treatment, wherein a molar fraction of the metal component to the total of the particles and the metal component in the liquid medium ranges from 1 mole % to 3 mole %.

When the starting particles are subjected to the thermal treatment under pressurized conditions, there can be formed alumina particles wherein the metal component is deposited as a surface layer in the form of a solid solution on individual particles. It has been found that when using the thus obtained alumina particles, a metal aluminate crystal phase can be formed on the surface of individual particles by sintering them at a temperature lower than an ordinary sintering temperature used to obtain a metal aluminate crystal phase. More particularly, when the particles obtained after the heat treatment are dried and sintered at a temperature of from 900° C. to lower than 1200° C., a metal aluminate crystal phase develops as a layer on the surface of individual alumina particles by conversion of the solid solution thereinto.

As stated hereinbefore, the metal aluminate crystal phase is excellent in heat resistance. Therefore, the alumina particles having a metal aluminate crystal phase on the surface thereof is improved in heat resistance over metal aluminate crystal phase-free alumina particles. The alumina particles obtained after the heat treatment and sintering do not undergo a significant change in particle size. Accordingly, when using starting particles having a size on the order of nanometers, there can be obtained alumina particles having a metal aluminate surface layer on the order of nanometers.

The alumina particles obtained above have a small size on the order of nanometers and exhibits a good heat resistance in the vicinity of 1000° C. It will be noted that when the alumina particles obtained after the heat treatment and prior to sintering according to the invention are used in practical applications in the vicinity of 1000° C. or over, a metal aluminate crystal phase develops on the surface thereof. The resulting alumina particles are substantially equal in characteristic properties to the alumina particles obtained after the sintering. In this sense, the alumina particles after the heat treatment and prior to the sintering may be regarded as being excellent in heat resistance.

### EMBODIMENTS OF THE INVENTION

The method for manufacturing alumina particles according to the invention comprises providing a liquid medium containing starting alumina particles and a metal component used to form a metal aluminate, and subjecting the particles dispersed in the liquid medium and the metal component to thermal treatment under pressurized conditions wherein a molar fraction of the metal component to the total of the particles and the metal component in the liquid medium is from 1 to 3 mole %. Thereafter, the alumina particles are appropriately dried, for example, at a temperature of 80 to 150° C. for 5 to 48 hours and sintered at a temperature ranging from 900° C. to lower than 1200° C. for a time of 2 to 10 hours. As a result, there can be obtained alumina particles wherein a metal aluminate crystal phase is formed as a surface layer on individual particles.

The starting alumina particles are those particles made of γ-alumina or boehmite alumina hydrate. The boehmite alumina hydrate means aluminium hydroxide oxide (AlOOH). Because the thermal treatment of this compound results in alumina, the boehmite alumina hydrate is a precursor of alumina. The reason why particles of γ-alumina or boehmite alumina hydrate are used is that when such particles are thermally treated in a liquid medium under pressurized or hydrothermal conditions, the particle size does not change significantly as experimentally confirmed by us.

The starting alumina particles are preferably in such a size range of 10 nm to 100 nm that alumina particles after sintering have a size on the order of nanometers, especially ranging from 10 nm to 100 nm.

The metal component for the metal alumina includes La, Ba, Mg, Ce, Na, K, Sr, Ca or a mixture thereof. There metal components are added to the liquid medium in the form of salts such as a nitrate, sulfate, hydrochloride, phosphate, oxide or the like. Of the metal components, nitrates, hydrochlorides and the like are preferred because they are good at solubility and give little influence of a decomposed product thereof on a product.

The liquid medium containing starting alumina particles and a metal component is prepared by dispersing starting alumina particles in the liquid medium. Thereafter, a metal component in the form of a salt is dissolved in the dispersion. The liquid medium used in the practice of the invention includes water, ethanol, isopropanol or a mixture thereof, of which water is preferred because of the ease in handling and availability. The amount of the metal salt is such that a molar fraction of the metal salt relative to the total of the alumina particles and the metal salt present in the liquid medium is within a range of 1 mol % to 3 mol %. Preferably, the molar fraction ranges from 1 mol % to 2 mol %. As mentioned above, the molar fraction used herein is calculated from the equation of (mols of metal salt)/(moles of alumina particles+mols of metal salt)×100(%).

In order to permit the reactions involved during the thermal treatment to proceed smoothly, the starting alumina particles are used in an amount of 2 to 5 wt % relative to the liquid medium.

The thermal treatment is carried out by use of a pressure-resistant container such as an autoclave, or by irradiation of ultrasonic waves.

The heating method using an autoclave is such that a liquid medium containing starting alumina particles and a metal component is placed in an autoclave capable of establishing a high pressure thereinside and hermetically closed, followed by heating the liquid medium inside the autoclave.

The liquid medium in which the starting alumina particles and a metal component are contained for dispersing the particles and dissolving the metal component include water, ethanol, isopropanol or a mixture thereof.

The heating temperature during the thermal treatment ranges from a temperature, which ensures the formation of a metal aluminate crystal phase as a surface layer of individual alumina particles after sintering or the formation of a solid solution on the particle surface, to a temperature at which mutual aggregation of the particles can be suppressed. As a matter of course, the vapor pressure inside the autoclave correspond to a heating temperature. When water is used as the liquid medium, the heating temperature is set at 120° C. to 180° C. and the heating time is, for example, at about 24 hours. According to the results of a test made by us, it has been found that when the thermal treatment is carried out at a temperature of 120° C. or over for a time defined above, a metal aluminate crystal phase is formed on the surface of individual alumina particles after sintering. If the heat temperature is at 180° C. or below, mutual aggregation of the particles is suppressed. The heating time may be arbitrarily changed within a range where a metal aluminate crystal phase can be formed on the surface of the individual particles by sintering and generally ranges from 2 to 48 hours.

With ethanol and isopropanol, similar results are obtained when the heating temperature ranges from 80 to 120° C. for ethanol and also for isopropanol. In this case, a similar heating time may be used.

When using a pressure-resistant container, the container can be heated by means of a heater provided outside the container. Alternatively, a microwave irradiator may be used, with which a microwave is irradiated to the inside of the container so as to directly heat the liquid medium in the container.

On the other hand, ultrasonic irradiation may also be made in such a way that a liquid medium comprising starting alumina particles and a metal component is placed in a container and an ultrasonic wave is irradiated to the alumina particles and the metal component in the liquid medium to heat them. In this irradiation method, the container may not be hermetically closed. For instance, the frequency of an ultrasonic wave is set at 25 kHz to 100 kHz and the ultrasonic wave is so applied that the temperature of the liquid medium is at 60° C. or below, for example. Upon the ultrasonic irradiation in this way, the liquid medium undergoes locally, instantaneously pressurized conditions of a pressure higher than an atmospheric pressure, e.g. several hundreds of atmospheric pressures, and a temperature of several thousands of degrees centigrade. Thus, the alumina particles and metal component in the liquid medium can be heated while pressurizing. The ultrasonic irradiation is usually continued for a time of 5 to 30 minutes.

When the starting alumina particles and metal component is thermally heated while pressurizing under such conditions as set out above, there can be obtained alumina particles individually having a surface layer wherein the metal component is converted to a solid solution in the form of a film. It is assumed that the metal component selectively undergoes solid solution with a portion of the alumina particles where the surface layer becomes amorphous through hydration. It is believed that the alumina particles obtained after the thermal treatment have a crystal phase different from a γ phase or θ phase.

The thermally treated particles are dried in a usual manner under conditions as set out before and sintered at a temperature of 900° C. to lower than 1200° C. to provide alumina particles wherein a metal aluminate crystal layer exists at the surface layer. The metal aluminate crystal phase exists wholly or partly over the surface layer of individual alumina particles. Moreover, the metal aluminate crystal phase may exist around a central portion of the alumina particle.

In general, a metal aluminate crystal phase is one which is formed in a temperature range of not lower than 1200° C. The reason why a lower temperature range can be used to form a metal aluminate crystal phase according to the invention is considered as follows. In the practice of the invention, starting alumina particles and a metal component are thermally treated prior to sintering, so that the metal component undergoes solid solution in the form of a film on or in the surface layer of the alumina particles. It is thus considered that the thermal treatment prior to sintering permits a metal aluminate crystal phase to be developed and grown by sintering at temperatures as low as 900° C. to not higher than 1200° C.

A metal aluminate crystal phase is excellent in heat resistance in the vicinity of 1000° C., for which formation of a metal aluminate at a surface layer portion of the alumina particles enables the alumina particles to be imparted with such a high heat resistance as will not be expected in known alumina particles.

Further, little change is involved in the size of alumina particles prior to and after the thermal treatment and sintering. This is considered for the reason that the development of the metal aluminate crystal phase upon sintering acts to suppress the particles from coarsening owing to the mutual aggregation or sintering of the particles, thereby obtaining monodispersed primary particles.

In this way, according to the invention, there can be obtained alumina particles that have a size on the order of nanometers, especially ranging from 10 nm to 100 nm, and exhibit a high heat resistance in the vicinity of 1000° C.

According to the invention, when the alumina particles obtained after the thermal treatment and prior to sintering are used in the vicinity of 1000° C., a metal aluminate crystal phase develops on or in the surface of individual particles, like the case where sintering is carried out. The thermally treated alumina particles, but not sintered, may be regarded as being excellent in heat resistance and can be applied as a carrier for catalyst for automotives, like sintered alumina particles.

Where a catalyst is supported on such alumina particles, for example, a catalyst component is added to the alumina particles obtained after the thermal treatment and calcined at a temperature of about 800° C., followed by sintering at a temperature of not lower than 900° C. to lower than 1200° C., thereby providing heat-resistant alumina particles supporting the catalyst component thereon. As a matter of course, the step of thermally treating starting alumina particles and a metal component may be carried out separately from the calcination and sintering steps, for example in different places.

Examples and comparative examples are now described. Samples were prepared according to the procedures of the following examples 1-6 and comparative examples 1-4 and analyzed as particularly described below.

### EXAMPLE 1

30 g of alumina sol 520, made by Nissan Chemical Industries, Limited, was charged into 120 ml of water to provide a dispersion of aluminium particles. The alumina particles in the alumina sol were made up of boehmite and had a size of 20 nm.

Subsequently, while agitating the dispersion with a stirrer, 10 g of water dissolving 1.0 g of lanthanum nitrate therein was charged into the dispersion. The amount of the lanthanum nitrate corresponded to a molar fraction of 2 mol %.

Thereafter, the dispersion was placed in an autoclave capable of establishing a high pressure thereinside. The autoclave was hermetically closed and heated at an inner temperature of 120° C. for 24 hours.

After the heating, the resulting alumina particles were dried at 80° C. for 24 hours and sintered at different temperatures of 800° C., 900° C., 1050° C. and 1200° C. for 5 hours, thereby obtaining samples.

### EXAMPLE 2

The general procedure of Example 1 was repeated except that lanthanum nitrate was replaced by barium nitrate, thereby obtaining samples.

### EXAMPLE 3

The general procedure of Example 1 was repeated except that lanthanum nitrate was replaced by magnesium nitrate, thereby obtaining samples.

### EXAMPLE 4

An alumina dispersion was prepared in the following manner. More particularly, 45 g of aluminium nitrate was dissolved in 1700 ml of water in a beaker. While agitating the solution with a stirrer, 80 ml of diethanolamine was added to the solution. After further agitation for 24 hours, the resulting product was centrifugally separated and washed three times with water, after which nitric acid was added to the solution to adjust a pH thereof to 4 or below, thereby obtaining an alumina dispersion. The particles in the alumina dispersion were made of boehmite and had a size of 15 nm.

The general procedure of Example 1 was subsequently repeated using the alumina dispersion set out above, thereby providing samples.

### EXAMPLE 5

The general procedure of Example 1 was repeated except that an ordinary container was used and heating in the autoclave was replaced by heating by ultrasonic irradiation wherein a heating temperature was set at 60° C. and heating was continued for 30 minutes. In this way, samples were made.

### EXAMPLE 6

The general procedure of Example 1 was repeated except that the amount of lanthanum nitrate was changed to 0.5 g. It will be noted that this amount corresponds to a molar ratio of 1 mol %.

### EXAMPLE 7

The general procedure of Example 1 was repeated except that the heating conditions in the autoclave were changed to 180° C. and 5 hours, thereby obtaining samples.

### COMPARATIVE EXAMPLE 1

In this comparative example, the hating treatment using the autoclave was not carried out. More particularly, 30 g of alumina sol 520, made by Nissan Chemical Industries, Limited, was dissolved in 120 ml of water to provided a dispersion of alumina particles. While agitating this dispersion with a stirrer, 10 ml of water dissolving 1.0 g of lanthanum nitrate was charged into the dispersion. The resulting alumina particles were dried and sintered at different temperatures as used before to obtain samples.

### COMPARATIVE EXAMPLE 2

The general procedure of Example 4 was repeated except that the thermal treatment was not carried out. More particularly, 45 g of aluminium nitrate was dissolved in 1700 ml of water. While agitating the solution with a stirrer, 80 ml of diethanolamine was added to the solution. After further agitation for 24 hours, the resulting product was centrifugally separated and washed three times with water, after which nitric acid was added to the solution to adjust a pH thereof to 4 or below, thereby obtaining an alumina dispersion. Alumina particles were separated from the dispersion and dried, followed by sintering at different temperatures to obtain samples.

### REFERENCE 1

The general procedure of Example 1 was repeated except that the amount of lanthanum nitrate was changed to 0.25 g thereby obtaining samples. This amount corresponds to a molar fraction of 0.5 mol %.

### REFERENCE 2

The general procedure of Example 1 was repeated except that the amount of lanthanum nitrate was changed to 2 g thereby obtaining samples. This amount corresponds to a molar fraction of 4 mol %.

### COMPARATIVE EXAMPLE 3

The general procedure of Example 1 was repeated except that lanthanum nitrate was not added and alumina particles alone were heated in the autoclave, thereby obtaining samples.

### COMPARATIVE EXAMPLE 4

The general procedure of Example 7 was repeated except that lanthanum nitrate was not added and the alumina particles alone were heated in the autoclave, thereby obtaining samples.

The samples obtained in the examples and comparative examples were subjected to measurement of an average particle size by transmission electron microscopy (TEM) and also to measurement with an X-ray diffractometer (XRD) to confirm a precipitated crystal phase. The results are shown in Tables 1 and 2. The specific surface areas of the alumina particles of the samples made in the examples and comparative examples are shown in Table 3.

TABLE 1

| | | | Average | |
|---|---|---|---|---|
| | | | primary | |
| | Sintering | | particle | |
| | temperature | | size (nm) | XRD pattern |
| Example 1 | 800° | C. | 20 | Al₂O₃ |
| | 900° | C. | 20 | Al₂O₃ + lanthanum aluminate |
| | 1050° | C. | 20 | Al₂O₃ + lanthanum aluminate |
| | 1200° | C. | 20 | Al₂O₃ + lanthanum aluminate |
| Example 2 | 800° | C. | 20 | Al₂O₃ |
| | 900° | C. | 20 | Al₂O₃ + barium aluminate |
| | 1050° | C. | 20 | Al₂O₃ + barium aluminate |
| | 1200° | C. | 20 | Al₂O₃ + barium aluminate |
| Example 3 | 800° | C. | 50 | Al₂O₃ |
| | 900° | C. | 50 | Al₂O₃ + magnesium aluminate |
| | 1050° | C. | 50 | Al₂O₃ + magnesium aluminate |
| | 1200° | C. | 50 | Al₂O₃ + magnesium aluminate |
| Example 4 | 800° | C. | 15 | Al₂O₃ |
| | 900° | C. | 15 | Al₂O₃ + lanthanum aluminate |
| | 1050° | C. | 15 | Al₂O₃ + lanthanum aluminate |
| | 1200° | C. | 15 | Al₂O₃ + lanthanum aluminate |
| Example 5 | 800° | C. | 20 | Al₂O₃ |
| | 900° | C. | 20 | Al₂O₃ + lanthanum aluminate |
| | 1050° | C. | 20 | Al₂O₃ + lanthanum aluminate |
| | 1200° | C. | 20 | Al₂O₃ + lanthanum aluminate |
| Example 6 | 800° | C. | 25 | Al₂O₃ |
| | 900° | C. | 25 | Al₂O₃ + lanthanum aluminate |
| | 1050° | C. | 25 | Al₂O₃ + lanthanum aluminate |
| | 1200° | C. | 25 | Al₂O₃ + lanthanum aluminate |
| Example 7 | 800° | C. | 20 | Al₂O₃ |
| | 900° | C. | 20 | Al₂O₃ + lanthanum aluminate |
| | 1050° | C. | 20 | Al₂O₃ + lanthanum aluminate |
| | 1200° | C. | 20 | Al₂O₃ + lanthanum aluminate |

TABLE 2

| | | | Average | |
|---|---|---|---|---|
| | | | primary | |
| | Sintering | | particle | |
| | temperature | | size (nm) | XRD pattern |
| Comparative | 800° | C. | 20 | Al₂O₃ + La₂O₃ |
| Example 1 | 900° | C. | 50 | Al₂O₃ + La₂O₃ |
| | 1050° | C. | 100 | Al₂O₃ + La₂O₃ |
| | 1200° | C. | 200 | Al₂O₃ + La₂O₃ |
| Comparative | 800° | C. | 10 | Al₂O₃ + La₂O₃ |
| Example 2 | 900° | C. | 20 | Al₂O₃ + La₂O₃ |
| | 1050° | C. | 50 | Al₂O₃ + La₂O₃ |
| | 1200° | C. | 100 | Al₂O₃ ++ La₂O₃ |
| Reference 1 | 800° | C. | 20 | Al₂O₃ |
| | 900° | C. | 50 | Al₂O₃ |
| | 1050° | C. | 70 | Al₂O₃ |
| | 1200° | C. | 100 | Al₂O₃ |
| Reference 2 | 800° | C. | 20 | Al₂O₃ |
| | 900° | C. | 25 | Al₂O₃ + lanthanum |
| | | | | aluminate + La₂O₃ |
| | 1050° | C. | 50 | Al₂O₃ + lanthanum |
| | | | | aluminate + La₂O₃ |
| | 1200° | C. | 50 | Al₂O₃ + lanthanum |
| | | | | aluminate + La₂O₃ |
| Comparative | 800° | C. | 20 | Al₂O₃ |
| Example 3 | 900° | C. | 70 | Al₂O₃ |
| | 1050° | C. | 100 | Al₂O₃ |
| | 1200° | C. | 150 | Al₂O₃ |
| Comparative | 800° | C. | 20 | Al₂O₃ |
| Example 4 | 900° | C. | 50 | Al₂O₃ |
| | 1050° | C. | 80 | Al₂O₃ |
| | 1200° | C. | 100 | Al₂O₃ |

TABLE 3

| | |
|---|---|
| Sintering | Specific surface |
| temperature | area (m²/cc) |

| | | | |
|---|---|---|---|
| Example 1 | 800° | C. | 100.7 |
| | 900° | C. | 109.2 |
| | 1050° | C. | 114.8 |
| | 1200° | C. | 108.5 |
| Example 7 | 800° | C. | 100.9 |
| | 900° | C. | 110.9 |
| | 1050° | C. | 104.7 |
| | 1200° | C. | 98.7 |
| Comparative | 800° | C. | 142.3 |
| Example 1 | 900° | C. | 118.3 |
| | 1050° | C. | 84.45 |
| | 1200° | C. | 60.25 |
| Comparative | 800° | C. | 199.1 |
| Example 2 | 900° | C. | 142 |
| | 1050° | C. | 105.2 |
| | 1200° | C. | 86.82 |
| Reference 1 | 800° | C. | 137 |
| | 900° | C. | 144.7 |
| | 1050° | C. | 139.4 |
| | 1200° | C. | 98.74 |
| Reference 2 | 800° | C. | 97.59 |
| | 900° | C. | 85.24 |
| | 1050° | C. | 85.01 |
| | 1200° | C. | 66.7 |
| Comparative | 800° | C. | 192.4 |
| Example 3 | 900° | C. | 146 |
| | 1050° | C. | 120.7 |
| | 1200° | C. | 90.8 |
| Comparative | 800° | C. | 172.5 |
| Example 4 | 900° | C. | 105.8 |
| | 1050° | C. | 108.4 |
| | 1200° | C. | 86.51 |

Examples 1, 7 and Comparative Example 1 are compared with each other. In Examples 1, 7, the results of the TEM observation in Table 1 reveal that all the samples obtained after the sintering are in the form of nanoparticles having a primary size of about 20 nm. Moreover, the results of the XRD measurement reveal that the samples after the sintering at 900° C. or over exhibit, aside from the crystal pattern of alumina (Al₂O₃), the crystal pattern resulting from lanthanum aluminate (LaAlO₃). It will be noted that although the XRD pattern has a broad peak, this is considered by the influence of the nanoparticles or incomplete crystallization. As shown in Table 3, the specific surface areas of all the samples after the sintering are in the range of about 100 to about 110 m²/cc with no significant difference therebetween. It will be noted that in Table 1, the specific surface areas of the samples after the sintering at different sintering temperatures in Example 1 are within an error range.

On the other hand, as shown in Table 2, it has been confirmed from the results of the XRD measurement of the samples of Comparative Example 1 that the crystal patterns of the samples after the sintering are those derived from alumina (Al₂O₃) and lanthanum oxide (La₂O₃), with no crystal pattern derived from lanthanum aluminate (LaAlO₃). Moreover, as shown in Table 3, the specific surface areas of the sintered samples tend to become smaller at higher sintering temperatures.

In this way, it has been confirmed from the results of Examples 1, 7 that when the sintering temperature is within a range of 900° C. to lower than 1200° C., the formation of lanthanum aluminate is formed while suppressing the article size from increasing. It should be noted that when the sintering temperature is set at 1200° C., the surface area becomes slightly smaller, so that the upper limit is defined as lower than 1200° C.

Thus, it has been confirmed from the comparison of the results of Examples 1, 7 with the results of Comparative Example 1 that if the sintering temperature ranges from 900° C. to lower than 1200° C., the lowering of the specific surface area owing to the high temperature level of sintering can be suppressed. Accordingly, if the alumina particles thermally treated in an autoclave are calcined at 800° C. and the particles are subsequently sintered at 900° C. to lower than 1200° C., the specific surface area of the particles is not decreased. Thus, it will be seen that the heat resistance of the alumina particles is improved.

In the afore-mentioned Japanese Laid-open Patent Application No. 2003-335517, it is described that a metal aluminate is formed by sintering a similar alumina composition at 1200° C. or over. In Comparative Example 1, no formation of a metal aluminate has been confirmed after sintering at 1200° C. This is considered for the reason that not only no thermal treatment is carried out, but also the amount of the metal component is smaller than that used in this Laid-open Application.

In Examples 2, 3 wherein the metal components are changed from Example 1, sintering in a temperature range of 900° C. to lower than 1200° C. permits metal aluminates to be formed on or in the alumina particles while suppressing the particle size from increasing, like Example 1, as is particularly shown in Table 1.

In example 3, the size of the sample particles after the sintering is at 50 nm, which is 2.5 times larger than the size of the starting particles. In the practice of the invention, an increase in the particle size can be suppressed to not greater than 2.5 times the original one.

In Example 4 wherein the alumina dispersion is changed from Example 1, similar results as in Example 1 are obtained. The comparison between Example 4 and Comparative Example 2 reveal that the specific surface area decreases with an increasing sintering temperature in Comparative Example 2 as shown in Table 3, whereas according to Example 4, the lowering of the specific surface area in the high temperature range of sintering can be suppressed like Example 1.

In Example 5 wherein ultrasonic irradiation is carried out for heating, it has been confirmed, as shown in Table 1, that the metal aluminate is formed on or in the alumina particles while suppressing the size from increasing when sintered at 900° C. to lower than 1200° C. like Example 1.

The comparison between Examples 1, 6 and References 1, 2 reveal that although the metal aluminate is formed on the alumina particles by sintering at 900° C. to lower than 1200° C. while suppressing the particle size from increasing in Examples 1, 6, no formation of a metal aluminate is confirmed in Reference 1. Moreover, in Reference 2, although the metal aluminate can be formed on he alumina particle while suppressing the size increase when sintering at 900° C. to lower than 1200° C., lanthanum oxide is also formed, so that the specific surface area significantly lowers owing to the sintering in the high temperature range. These results demonstrate that the molar fraction of the lanthanum nitrate preferably ranges from 1 to 2 mol %.

In Comparative Examples 3, 4 wherein the metal component is not added to the alumina dispersions of Examples 1, 7, the specific surface areas of the samples after the sintering tend to become smaller with an increasing sintering temperature, and the particle sizes increase with an increasing sintering temperature. This is considered because no metal component is present upon thermal treatment in an autoclave, so that no metal aluminate is formed by the heating, for which the crystal phase of the alumina is changed from γ to θ and thus, irregularities in the surfaces of the alumina particles decrease and the particles are allowed to be coarsened.

It will be noted that Japanese Lid-open Patent Application No. 2008-12527 describes that γ-alumina is thermally treated in a liquid in a pressurized condition along with a dispersant made of a water-soluble polymer in a temperature range of 180° C. to 240° C., there can be obtained alumina particles having an improved heat resistance while suppressing the particle size from increasing. In this connection, however, as will be seen from the results of Comparative Examples 3, 4, when using a thermal treating temperature of 120 to 180° C., the thermal treatment of alumina particles alone without use of a metal component does not lead to similar results as in Examples 1, 7.

What is claimed is:

1. A method for manufacturing alumina particles, the method comprising providing starting particles made of γ-alumina or boehmite alumina hydrate and a metal component selected from at least one of La, Ba, Mg, Ce, Na, K, Sr and Ca, both contained in a liquid medium, and subjecting the particles dispersed in the liquid medium and the metal component to thermal treatment in the liquid medium under pressurized conditions wherein a molar fraction of the metal component to the total of the particles and the metal component in the liquid medium ranges from 1 mole % to 3 mole %.

2. The method according to claim 1, wherein after drying the particles, the dried particles are sintered at a temperature of from 900° C. to lower than 1200° C.

3. The method according to claim 1, wherein said liquid medium consists of water, ethanol, isopropanol or a mixture thereof.

4. The method according to claim 1, wherein the thermal treatment is carried out in such a way that said liquid medium containing said starting particles and said metal component is placed in a closed container and are thermally treated.

5. The method according to claim 4, wherein said starting particles and said metal component is thermally treated by irradiation of a micro wave.

6. The method according to claim 4, wherein said liquid medium consists of water and a thermal treating temperature is set at 120° C. to 180° C., under the thermal treatment is carried out at a pressure corresponding to the heating temperature.

7. The method according to claim 1, wherein said liquid containing said particles and said metal component is thermally treated by ultrasonic irradiation.

8. The method according to claim 1, wherein said starting particles have a size from 10 nm to 100 nm.

9. The method according to claim 1, wherein the molar ratio ranges from 1 to 2 mole %.
